(19) United States
(12) Patent Application Publication
(10) Pub. No.: US 2024/0283258 A1
(43) Pub. Date: Aug. 22, 2024

(54) CELL BALANCING USING AN EXTERNAL POWER SOURCE

(71) Applicant: TEXAS INSTRUMENTS INCORPORATED, Dallas, TX (US)

(72) Inventors: Yang Wu, Wuhan (CN); Yihua Yang, Shanghai (CN); Xiaodong Cai, McKinney, TX (US); Bradford Hunter, Spicewood, TX (US)

(21) Appl. No.: 18/239,997

(22) Filed: Aug. 30, 2023

Related U.S. Application Data
(60) Provisional application No. 63/447,108, filed on Feb. 21, 2023.

(51) Int. Cl. H02J 7/00

(52) U.S. Cl. CPC H02J 7/0019; H02J 7/0047

(57) ABSTRACT

Described examples include a system having a power source having a first output terminal and a second output terminal and a controller. The system also has a selective charger coupled to the controller, the selective charger configured to couple, in response to instructions from the controller, the first output terminal of the power source to a first node that is configured to be coupled to a first terminal of a selected battery cell of two or more serially coupled battery cells, and couple the second output terminal of the power source to a second node configured to be coupled to a second battery terminal of the selected battery cell.

### CROSS-REFERENCE TO RELATED APPLICATIONS

This application claims the benefit under 35 U.S.C. § 119(e) to co-owned U.S. Provisional Patent Application Ser. No. 63/447,108, filed Feb. 21, 2023, entitled “Active Cell Balancing Using External Power Source, Current Source Injection and Multiplexer Method,” which is hereby incorporated by reference in its entirety herein.

### TECHNICAL FIELD

This relates generally to battery technology, and more particularly to recharging batteries.

### BACKGROUND

To use rechargeable batteries, such as lithium-ion cells, for high power applications, such as electric vehicles, the cells of the battery array must be at least partially arranged in series. Lithium-based batteries have a voltage of 3 to 4 volts, depending on the chemistry used in the cell. Some applications require hundreds of volts. Thus, many lithium-based battery cells are placed in series to provide the required voltage. However, due to heating, jostling, or other physical or chemical effects, a particular cell in a series of cells may discharge faster or slower than the others. When any cell in the series is depleted, the series can no longer provide power. In addition, recharging must stop when any cell in the series has reached its maximum capacity due, in part, to the dangers of overcharging. Therefore, to maximize charging of a series, and to maximize power extraction from the series, it is desirable to balance the charge on cells within the series.

### SUMMARY

In accordance with an example, a system includes a power source having a first output terminal and a second output terminal and a controller. The system also includes a selective charger coupled to the controller, the selective charger configured to couple, in response to instructions from the controller, the first output terminal of the power source to a first node that is configured to be coupled to a first terminal of a selected battery cell of two or more serially coupled battery cells, and couple the second output terminal of the power source to a second node configured to be coupled to a second battery terminal of the selected battery cell.

### BRIEF DESCRIPTION OF THE DRAWINGS

FIG. 1 is a schematic diagram of an example battery pack.

FIG. 2 is a schematic circuit diagram of an example selective charging circuit.

FIG. 3 are schematic circuit diagrams of example multiplexors.

FIG. 4 is a schematic circuit diagram of voltage monitoring for one cell, in an example.

FIG. 5 is another example charge balancing circuit.

### DETAILED DESCRIPTION

In the drawings, corresponding numerals and symbols generally refer to corresponding parts unless otherwise indicated. The drawings are not necessarily drawn to scale.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

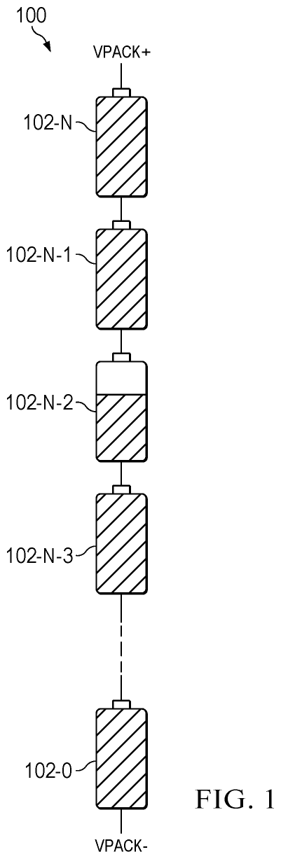

FIG. 1 is a schematic diagram of an example battery pack 100. Battery cells 102-0 through 102-N are coupled in series to provide a voltage N times the voltage of a single battery cell. Each battery has two battery terminals. The shading on the batteries indicates the state of charge of that battery. In this example, battery cell 102-N-2 has become unbalanced with the other battery cells. Specifically, battery cell 102-N-2 is not fully charged while the other battery cells are fully charged. This means that, as the energy stored in battery pack 100 is used, battery cell 102-N-2 will become fully depleted before the other battery cells. One dissipated battery cell may pull the voltage of the battery pack out of its acceptable operating range. Thus, this battery pack must be recharged sooner than necessary.

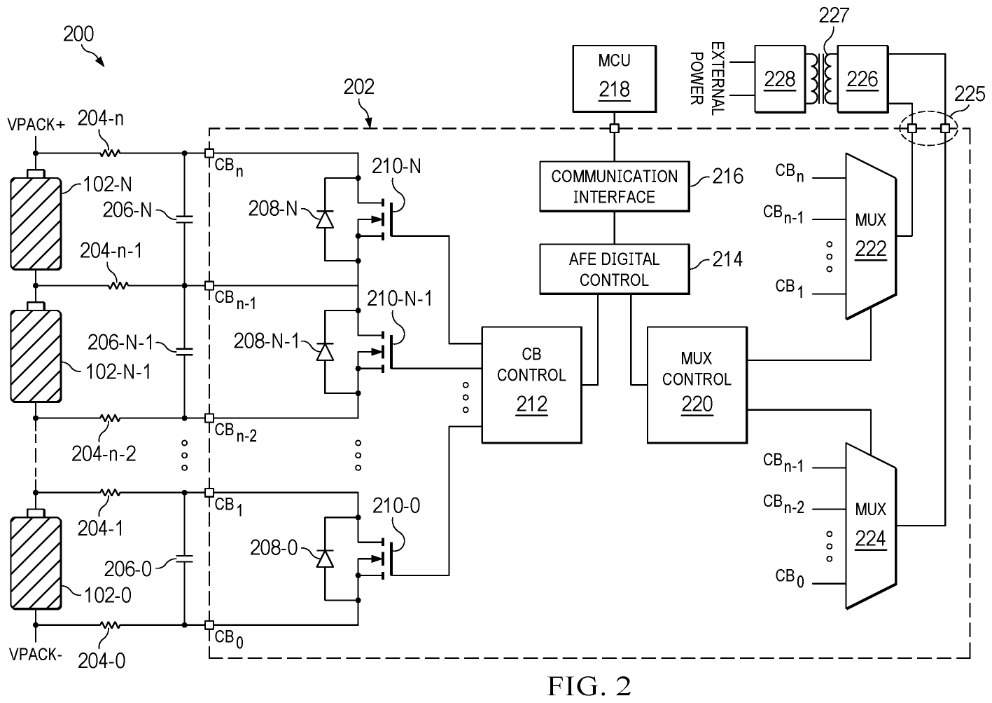

FIG. 2 is a schematic circuit diagram of an example selective charging circuit 200. Battery cells 102-0 through 102-N are arranged in a serially coupled battery pack. Resistors 204-0 through 204-n couple the battery nodes between the respective battery cells to cell balancing nodes including battery nodes CB₀ through CBₙ, which provide a connection from the battery cells to integrated circuit 202. In this example, n is equal to N+1, so for example, if there is one battery cell (N=1), then there will be two resistors (n=1+1). Capacitors 206-0 through 206-N are coupled across battery cells 102-0 through 102-N, respectively, to dissipate any spurious voltage spikes, and thus protect battery cells 102-0 through 102-N. Diodes 208-0 through 208-N are also coupled across battery cells 102-0 through 102-N, respectively, to dissipate any reverse power spikes. Integrated circuit 202 includes transistors 210-0 through 210-N, which are coupled across battery cells 102-0 through 102-N, respectively, to serve as switches. The gates of transistors 210-0 through 210-N are coupled to cell balancing control 212. In this example, transistors 210-0 through 210-N are field effect transistors, but in other examples, one or more of transistors 210-0 through 210-N may be other types of transistors such as bipolar junction transistors.

If at least one battery cell of the battery cells 102-0 to 102-N is overcharged relative to the other battery cells, CB control 212 can turn on transistors 210-0 through 210-N that are coupled to the overcharged cell(s) to discharge the overcharge through the resistors coupled to the overcharged cells. Processor 218 (labeled main control unit or MCU in FIG. 2) provides instructions to perform this operation through communication interface 216 and analog front end (AFE) digital control 214. In some configurations, processor 218 is a separate integrated circuit. That is, processor 218 is formed on a separate substrate from integrated circuit 202. In other configurations, cell balancing control 212, AFE digital control 214, communication interface 216, multiplexor controller 220, multiplexor 222, and multiplexor 224 may or may not be on one or more separate integrated circuits.

Another balancing method is provided by external power source 228. External power source 228 can be a separate battery pack, power derived from an external charging station, or power derived from one or more other sources. Power converter 226 is shown in FIG. 2 coupled to external power source 228 via transformer 227 where the input coil provides two isolator input terminals and the output coil provides two isolator output terminals. In this example, transformer 227 serves as a power isolator. However, this configuration is only an example. Any power conversion system that provides the proper voltage and current for charging one of battery cells 102-0 through 102-N can be used. That is, assume battery cells 102-0 through 102-N each comprise a 3.5 V cell. The voltage provided by power converter 226 would then provide a voltage that, taking into account voltage drops caused by intervening circuitry, would apply slightly more than 3.5 V to a charging cell. One output terminal from power converter 226 is coupled to multiplexor 222 via one of power input terminals 225 on integrated circuit 202. The other output terminal from power converter 226 is coupled to multiplexor 224 via the other one of power input terminals 225 on integrated circuit 202. Multiplexor 222 and multiplexor 224 are controlled by multiplexor controller 220, which is controlled by processor 218 through communication interface 216 and AFE digital control 214. As an example, assume battery cell 102-N-1 has a voltage lower than the other battery cells in an example battery pack comprising battery cells 102-0, 102-N, and 102-N-1. To balance battery cell 102-N-1, multiplexor 222 is used to couple one output lead of power converter 226 to charge battery node CBₙ₋₁ and multiplexor 224 is used to couple the other output lead from power converter 226 to charge battery node CBₙ₋₂, thus providing charging energy to bring battery cell 102-N-1 in balance with the other battery cells in the example battery pack.

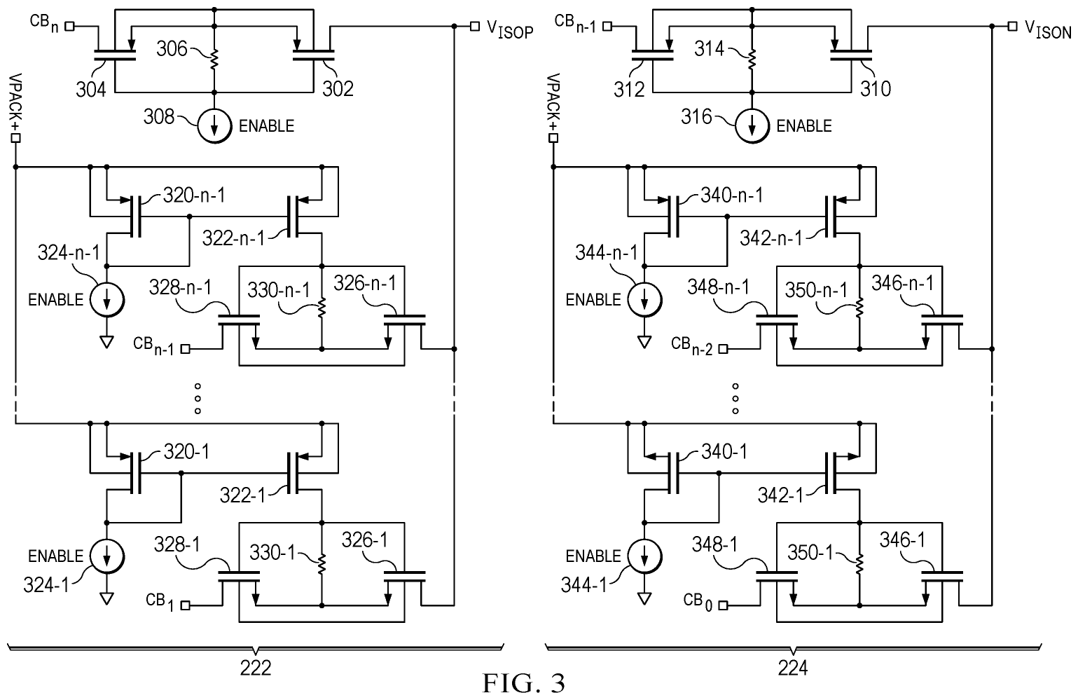

FIG. 3 are schematic circuit diagrams of example multiplexor 222 and example multiplexor 224 (FIG. 2). V_{ISOP} is the positive lead from power converter 226. A particular connection from V_{ISOP} to the selected cell balancing node of CBn to CB1 is made by enabling one of current source 308 or one of current sources 324-n to 324-1. P field effect transistor (PFET) 302 and PFET 304 provide the coupling to battery node CBn. When current source 308 is on, the gates of PFET 302 and PFET 304 are pulled low and thus PFET 302 and PFET 304 are conductive or ON. Thus, current flow from V_{ISOP} to battery node CBn. The current through resistor 306 is limited by current source 308, so most of the current goes to the charging battery. In addition, the current through resistor 306 provides a voltage drop that biases PFET 302 and PFET 304. When current source 308 is shut off, the gates of PFET 302 and PFET 304 are pulled high by V_{ISOP} through resistor 306, thus rendering PFET 302 and PFET 304 non-conductive or OFF.

For the selective connections to cell balancing nodes CBₙ₋₁ through CB₁, the respective one of current sources 324-n-1 through 324-1 are enabled. The current through current source 324-x (where “x” designates one of the 1 through n−1 cell balancing nodes) is mirrored through PFET 320-x to PFET 322-x. This mirrored current is applied to the gates of N field effect transistor (NFET) 328-x and NFET 326-x, thus rendering these transistors conductive or ON. The current through resistor 330-x is limited by the current through PFET 322-x. The current through PFET 322-x also biases NFET 328-x and 326-x. When current source 324-x is turned off, the gates of NFET 328-x and NFET 326-x are pulled to V_{ISOP}, which renders NFET 328-x and NFET 326-x non-conductive or OFF.

The corresponding portions of multiplexor 224 operate in a similar manner. That is, PFET 312 operates in a similar manner to PFET 304. PFET 310 operates in a similar manner to PFET 302. Resistor 314 operates in a similar manner to resistor 306. Current source 316 operates in a similar manner to current source 308. Current source 344-n-1 through current source 344-1 operate in a similar manner to current source 324-n-1 through, 324-1, respectively. PFET 340-n-1 through PFET 340-1 operate in a similar manner to current PFET 320-n-1 through PFET 320-1, respectively. PFET 342-n-1 through PFET 342-1 operate in a similar manner to current PFET 322-n-1 through PFET 322-1, respectively. NFET 348-n-1 through NFET 348-1 operate in a similar manner to NFET 328-n-1 through NFET 328-1, respectively. NFET 346-n-1 through NFET 346-1 operate in a similar manner to NFET 326-n-1 through NFET 326-1, respectively. Resistor 350-n-1 through resistor 350-1 operate in a similar manner to resistor 330-n-1 through resistor 330-1, respectively. Of note, the selective connections coupled to battery node CBₙ in multiplexor 222 and battery node CBₙ₋₁ in multiplexor 224 do not utilize a mirrored current source because there is not enough voltage headroom in this circuit to allow using a mirrored current source. That is, the voltages on battery node CBₙ and battery node CBₙ₋₁ are too close to V_{PACK}+, which is used to drive the connections to the other nodes.

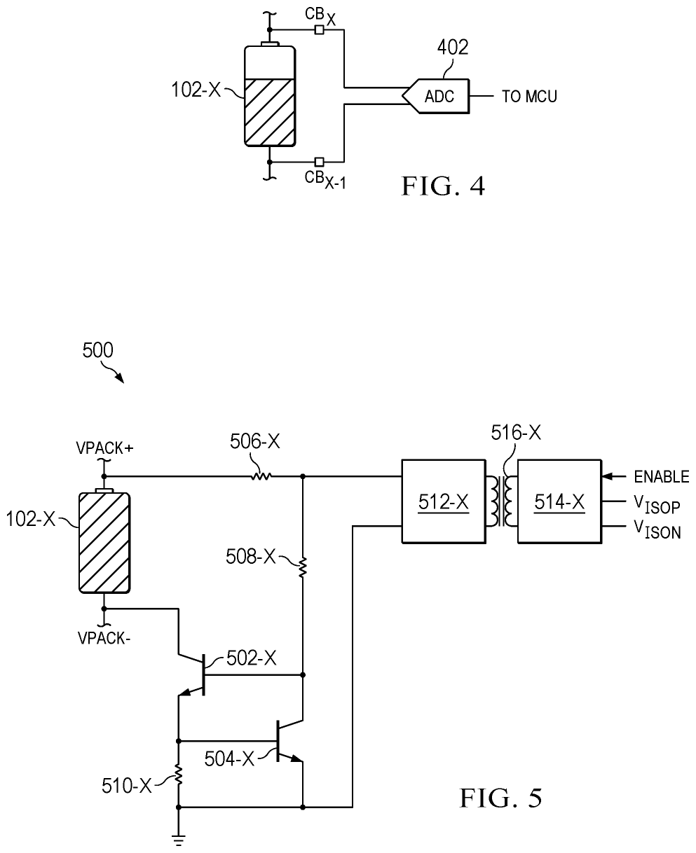

FIG. 4 is a schematic circuit diagram of voltage monitoring for one cell 102-X, where a similar circuit is provided for each of the cells 102-0 through 102-N. Across each cell, an analog to digital converter (ADC) 402 is coupled between each battery node CB_{X} and its adjacent battery node CB_{X-1} and serve as voltage measuring devices. In another example, one ADC 402 or a smaller number of ADCs than the number of cells may be used and coupled by a multiplexor to the cell to be measured. The multiplexor can then rotate the coupling to the cells over a time period to measure all of the cells. The output of ADC 402 is a digital signal representing the voltage across cell 102-X. ADC 402 provides this signal to processor 218 via communications interface 216 (FIG. 2). The voltage on a cell drops slightly as the cell is discharged. The relationship between the voltage across the cell and the cell's state of charge is a known function. Therefore, processor 218 (FIG. 2) can determine the state of charge of each cell by monitoring the voltage across each cell.

FIG. 5 is another example charge balancing circuit 500. In this example, a voltage isolation circuit is provided for each battery cell 102-X. Specifically, external voltage input 514-X includes connections to the outside power source (V_{ISOP} and V_{ISON}) and an Enable input. In this example, transformer 516-X isolates driver 512-X from external voltage input 514-X. External voltage input 514-X, transformer 516-X and driver 512-X condition the power for use to charge the battery cell 102-X. This is only one example and other power conditioning circuits can be used.

When external voltage input 514-X is enabled, positive bias is applied to the base of transistor 502-X through resistor 508-X. This makes transistor 502-X conductive and power flows through resistor 506-x to the positive battery node of battery cell 102-X, through transistor 502-X, through resistor 510-X back to driver 512-X or to ground. If too much current is flowing, the voltage drop across resistor 510-X forward biases transistor 504-X, which pulls some of the bias from the base of transistor 502-X. This limits the current through the cell to a selected value to avoid overheating of battery cell 102-X and other damaging effects of excessive charging current. Therefore, each battery cell in charge balancing circuit 500 can be separately charged to provide cell balancing.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “ON” or “enabled” means that the conduction channel of the FET is present and drain current may flow through the FET. References herein to a FET being “OFF” or “disabled” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

What is claimed is:

1. A system comprising:
a power source having a first output terminal and a second output terminal;
a controller; and
a selective charger coupled to the controller, the selective charger configured to couple, in response to instructions from the controller, the first output terminal of the power source to a first node that is configured to be coupled to a first battery node of a selected battery cell of two or more serially coupled battery cells, and couple the second output terminal of the power source to a second node configured to be coupled to a second battery node of the selected battery cell.

2. The system of claim 1, wherein the selective charger includes:
a first multiplexor configured to selectively, conductively couple the first output terminal to a selected first node; and
a second multiplexor configured to selectively, conductively couple the second output terminal to a selected second node.

3. The system of claim 1, wherein the selective charger includes:
power isolators having a first isolator input coupled to the first output terminal of the power source and having a second isolator input terminal coupled to the second output terminal of the power source, the power isolators having a first isolator output coupled to a respective first node of three or more nodes and a second isolator output terminal coupled to a respective second node of the three or more nodes, the power isolators also having an enable input coupled to the controller.

4. The system of claim 1, wherein the power source includes a power source and an isolator between the power source and the first output terminal and the second output terminal.

5. The system of claim 4, wherein the isolator is a transformer.

6. The system of claim 1, further comprising a switch and a resistor in series coupled between a respective first node of three or more nodes and a respective second node of the three or more nodes, wherein the controller controls the switch.

7. The system of claim 1, wherein the controller includes a voltage measuring device configured to measure a voltage between each a respective first node of three or more nodes and a respective second node of the three or more nodes.

8. An integrated circuit comprising:
two or more battery nodes configured to couple to battery cells coupled in series; and
a selective charger configured to couple a first output terminal of a power source to a first battery terminal of the two or more battery nodes and to couple a second output terminal of the power source to a second battery node of the two or more battery terminals.

9. The integrated circuit of claim 8, wherein the selective charger includes:
a first multiplexor configured to selectively couple to a first terminal of the power source to a selected first battery node; and
a second multiplexor configured to selectively couple a second terminal of the power source to a selected second battery node.

10. The integrated circuit of claim 8, wherein the selective charger includes:
power isolators having a first isolator input coupled to the first output terminal of the power source and having a second isolator input terminal coupled to the second output terminal of the power source, the power isolators having a first isolator output coupled to a respective one of first battery nodes and a second isolator output terminal coupled to a respective one of second battery nodes, the power isolators also having an enable input configured to couple to a controller.

11. The integrated circuit of claim 8, further comprising a controller configured to control the selective charger.

12. The integrated circuit of claim 11, further comprising a switch and a resistor in series coupled between a respective first node of three or more nodes and a respective second node of the three or more nodes, wherein the controller controls the switch.

13. The integrated circuit of claim 8, wherein the power source includes a power source and an isolator between the power source and the first output terminal and the second output terminal.

14. The integrated circuit of claim 13, wherein the isolator is a transformer.

15. The integrated circuit of claim 8, further including a voltage measuring device configured to measure a voltage between two battery nodes.

16. A method comprising:
receiving, at a front end on an integrated circuit, an instruction from a processor; and
in response to the instruction, the front end coupling a first power input terminal on the integrated circuit to a first battery node, the front end also coupling a second power input terminal on the integrated circuit to a second battery node, wherein the first power input terminal and second power input terminal are configured to connect to a power source, and wherein the first battery node and the second battery node are configured to couple to a series coupled set of batteries, and wherein the first battery node and the second battery node are configured to couple across one of the batteries in the set of batteries.

17. The method of claim 16, wherein the front end couples the first power input terminal to the first battery node using a first multiplexor, and the front end couples the second power input terminal to the second battery node using a second multiplexor.

18. The method of claim 16, wherein:
the front end couples the first power input terminal and the second power input terminal to the first battery node and the second battery node, respectively, using a power isolators having a first isolator input coupled to the first power input terminal and having a second isolator input terminal coupled to the second power input terminal, the power isolators having a first isolator output coupled to the first battery node and a second isolator output terminal coupled to the second battery node the power isolators also having an enable input coupled to the front end.

19. The method of claim 16, wherein the processor is on a separate substrate from the integrated circuit.

20. The method of claim 16, further including measuring a voltage of each of the batteries in the set of batteries.
